(19) United States
(12) Patent Application Publication
(10) Pub. No.: US 2025/0190122 A1
(43) Pub. Date: Jun. 12, 2025

(54) ULTRA-HIGH ENDURANCE STORAGE CLASS MEMORY TO REDUCE STORAGE CAPACITANCE IN A MEMORY SUB-SYSTEM

(71) Applicant: Micron Technology, Inc., Boise, ID (US)

(72) Inventors: Kishore Kumar Muchherla, San Jose, CA (US); Suresh Rajgopal, San Diego, CA (US); William Akin, Morgan Hill, CA (US); John E. Maroney, Irvine, CA (US); Akira Goda, Tokyo (JP); William Melton, Shingle Springs, CA (US); Mark A. Helm, Santa Cruz, CA (US)

(21) Appl. No.: 18/969,974

(22) Filed: Dec. 5, 2024

Related U.S. Application Data
(60) Provisional application No. 63/607,848, filed on Dec. 8, 2023.

(51) Int. Cl. G06F 3/06

(52) U.S. Cl. CPC G06F 3/0619; G06F 3/0659; G06F 3/0673

(57) ABSTRACT

A processing device in a memory sub-system identifies a power loss event associated with the memory sub-system including a memory device and an ultra-high endurance storage class memory device. In response to the power loss event, the processing device further identifies a set of data corresponding to one or more in-flight operations associated with the memory device. The processing device further causes the set of data corresponding to the one or more in-flight operations to be stored in the ultra-high endurance storage class memory device. The processing device further causes execution of a data recovery operation using the set of data corresponding to the one or more in-flight operations to be stored in the ultra-high endurance storage class memory device.

### CROSS-REFERENCE TO RELATED APPLICATION

This application claims the benefit of U.S. Provisional Application No. 63/607,848, titled “Ultra-high Endurance Storage Class Memory to Reduce Storage Capacitance in a Memory Sub-system,” filed Dec. 8, 2023, which is hereby incorporated herein by reference in its entirety.

### TECHNICAL FIELD

Embodiments of the disclosure relate generally to memory sub-systems, and more specifically, relate to using ultra-high endurance storage class memory to reduce storage capacitance in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with one or more embodiments of the present disclosure.

FIG. 2 is a block diagram illustrating a memory sub-system configured for using ultra-high endurance storage class memory to manage the storage of host data in view of a power loss event, in accordance with one or more embodiments of the present disclosure.

FIG. 3 is a block diagram illustrating a memory sub-system configured for using ultra-high endurance storage class memory to manage storage of in-flight operations associated with host data in view of a power loss event, in accordance with one or more embodiments of the present disclosure.

FIG. 4 is a block diagram illustrating a memory sub-system configured for using ultra-high endurance storage class memory to manage the storage of host data in view of a power loss event, in accordance with one or more embodiments of the present disclosure.

FIG. 5 is a block diagram illustrating a memory sub-system configured to switch storage of host data from a memory device to an ultra-high endurance storage class memory in view of a power loss event, in accordance with one or more embodiments of the present disclosure.

FIG. 6 is a flow diagram of an example method of using ultra-high endurance storage class memory to store host data in view of a power loss event, in accordance with one or more embodiments of the present disclosure.

FIG. 7 is a block diagram of an example computer system in which embodiments of the present disclosure may operate.

### DETAILED DESCRIPTION

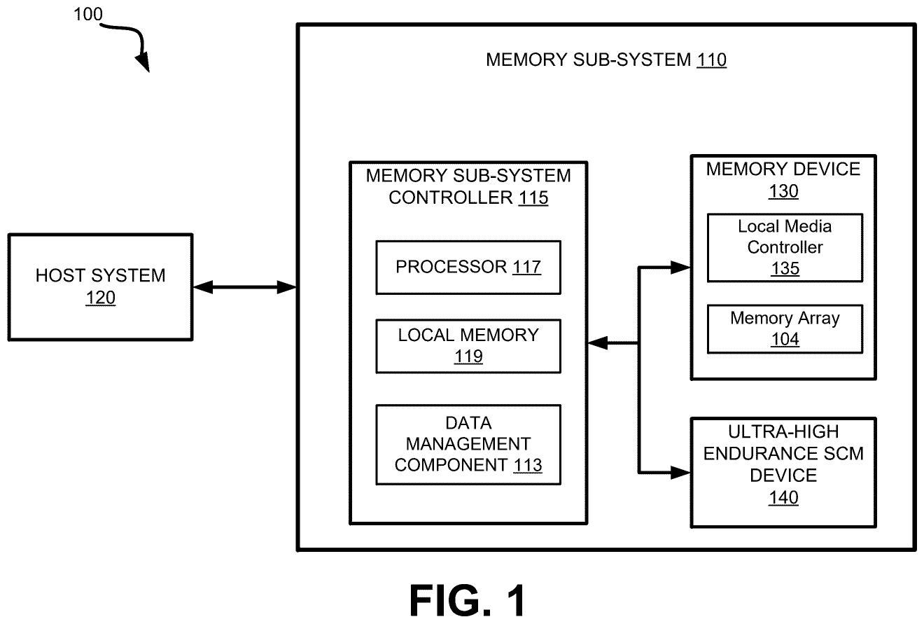

Aspects of the present disclosure are directed to using ultra-high endurance storage class memory to reduce storage capacitance in a memory sub-system. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. A given segment of one of those memory devices (e.g., a block) can be characterized based on the programming state of the memory cells associated with wordlines contained within the segment. Some memory devices use certain types of memory cells, such as quad-level cell (QLC) memory cells, which store four bits of data in each memory cell, which make it affordable to move more applications from legacy hard disk drives to newer memory sub-systems, such as NAND solid-state drives (SSDs). QLC memory is particularly well-tuned for read-intensive workloads, which are often seen in data center applications where data is normally generated once, and then read regularly to perform calculations and analysis. Thus, QLC memory is often considered to be fragile and used only for very light write workloads, as the endurance and Quality of Service (QoS) can limit usability in data center applications.

QLC programming algorithms typically have longer programming times (tPROG), particularly while programming 16-state memory devices. In such arrangements, system firmware acknowledges host data commits even before data is written to non-volatile memory. If there is a power loss event (e.g., an asynchronous power loss event or “APL”), backup storage capacitors are used to provide the power needed to complete the in-flight operations and move the volatile memory contents to non-volatile memory. In this regard, in the event of a power loss event, certain SSDs maintain several types of key data in volatile memory. Examples of data stored during a power loss event include host data stored in a write buffer (e.g., a dynamic random access memory (DRAM) or static access random memory (SRAM)), host data being written to the NAND (e.g., in-flight operations that have begun, but are not yet completed), and tables and other system metadata.

These capacitors included in the volatile memory (e.g., DRAM or SRAM) require energy to store and maintain a capacitive load, which increases the energy requirements of the memory device. Furthermore, the longer programming time associated with QLC memory devices requires the use of larger storage capacitor size. The larger-sized capacitors result in a higher cost, a greater expenditure of printed circuit board (PCB) area, and more significant capacitor reliability implications (e.g., issues with capacitor performance have a greater impact on the performance of the NAND).

Aspects of the present disclosure address the above and other deficiencies by using ultra-high endurance storage class memory to manage the storage of host data in response to a power loss event in a memory sub-system. Ultra-high endurance storage class memory can include any of a number of different types of memory media that are non-volatile, offer lower program/read latency and utilize less energy per bit than 3D flash NAND memory. Some examples of ultra-high endurance storage class memory include hybrid random access memory (HRAM), three-dimensional cross-point (“3D cross-point”) memory, or others. Depending on the embodiment, the ultra-high endurance storage class memory can be implemented within the same package as the NAND memory (i.e., within the same memory sub-system), or can be separately packaged.

In one embodiment, host data associated with one or more “in-flight” operations (herein the “in-flight data”) that are in progress at a time of a power loss event (e.g., an APL) is stored to an ultra-high endurance storage class memory configured as a buffer (also referred to as a “buffer” or “in-flight data buffer”). In this embodiment, the transferring or moving of the in-flight data from the ultra-high endurance storage class memory to the memory device (e.g., the NAND) is terminated if a condition is satisfied. In an embodiment, the condition is satisfied if an outstanding programming time (i.e., tPROG) associated with the one or more in-flight operations is greater than a threshold programming time. Advantageously, in this embodiment, the copy of the in-flight data is safely stored in the ultra-high endurance storage class memory, where it is available for data recovery purposes following the power loss event.

In an embodiment, the host data is concurrently written (i.e., mirrored) to both the ultra-high endurance storage class memory and the memory device. In this embodiment, in response to a power loss event, the writing of the in-flight data to the ultra-high endurance storage class memory continues, while the writing of the in-flight data to the memory device is terminated. In this embodiment, information identifying the one or more abandoned in-flight operations (i.e., operations for which the storing of the in-flight data to the memory device is abandoned) is stored as metadata to the ultra-high endurance storage class memory (e.g., for later use during data recovery processing). Advantageously, the in-flight data associated with the in-flight operations is stored in the ultra-high endurance storage class memory for use in a data recovery operation following completion of the power loss event.

In an embodiment, during normal operation, the host data is initially written to the memory device. In response to a power loss event, the writing of the in-flight data to the memory device is abandoned and the writing of the in-flight data is switched to the ultra-high endurance storage class memory. In this embodiment, the memory sub-system controller causes a switch of the writing of the in-flight data from the memory device to the ultra-high endurance storage class memory. In addition, in an embodiment, information identifying the one or more in-flight operations that are switched to the ultra-high endurance storage class memory is stored as metadata to the ultra-high endurance storage class memory (e.g., for later use during data recovery processing).

Advantages of the above-identified approaches include, but are not limited to, improved performance in the memory sub-system, a reduction in storage capacitance size in the memory device, and a savings of area or space on the printed circuit board due to the smaller capacitance size. Since ultra-high endurance storage class memory has higher endurance than QLC or SLC NAND memory, the size of the in-flight data buffer implemented using ultra-high endurance storage class memory need not be increased in size due to endurance concerns. Since larger portions of the NAND memory need not be dedicated for use as a data buffer, the overall storage capacity of the memory sub-system can be increased. In addition, as the write and read latency of the ultra-high endurance storage class memory is lower than that of SLC NAND memory, the entire programming time for host data can be reduced and less energy per bit is utilized to perform the programming operation. Advantageously, the storage capacitance requirement is reduced by using ultra-high endurance storage class memory to store data in view of a power loss event. Moreover, the use of ultra-high endurance storage class memory to store data in view of a power loss event further reduces the energy requirements of the memory device, since energy is not required to power capacitors, as is the case with typical volatile memory.

FIG. 1 illustrates an example computing system 100 that includes a memory sub-system 110 in accordance with some embodiments of the present disclosure. The memory sub-system 110 can include media, such as one or more ultra-high endurance storage class memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. For example, the ultra-high endurance storage class memory device 140 can include any of a number of different types of memory media or “cells” that are non-volatile and offer lower program/read latency than 3D NAND type flash memory, including both SLC memory and QLC memory. In addition, the ultra-high endurance storage class memory device 140 can have higher endurance (i.e., can tolerate a greater number of program/erase cycles) than memory device 130. Some examples of ultra-high endurance storage class memory include hybrid random access memory (HRAM), three-dimensional cross-point (“3D cross-point”) memory, or others.

Some examples of non-volatile memory devices (e.g., memory device(s) 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), or penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system 110 includes a data management component 113 that can implement a host data management policy that utilizes ultra-high endurance storage class memory device 140 as a buffer for host data. In an embodiment, the data management component 113 initially writes the host data to a portion of ultra-high endurance storage class memory device 140 (i.e., the ultra-high endurance storage class memory device 140 serves as a buffer for the host data). In one embodiment, data management component 113 determines a power loss event (e.g., an asynchronous power loss event) associated with the memory sub-system 110 and identifies one or more in-flight operations (e.g., in progress write operations) and allows the writing of data associated with the in-flight operations (i.e., in-flight data) to the ultra-high endurance storage class memory device 140 to complete. In this embodiment, the data management component 113 causes the writing of the in-flight data from the ultra-high endurance storage class memory device 140 to the memory device 130 to terminate if a condition is satisfied. In an embodiment, the condition is satisfied if a programming time associated with the writing of the in-flight data from the ultra-high endurance storage class memory device 140 to the memory device 130 is greater than a threshold programming time.

In an embodiment, the data management component 113 causes the host data relating to in-flight operations to be written to both the ultra-high endurance storage class memory device 140 and the memory device 130 concurrently. In this embodiment, in response to the identification of a power loss event, the data management component 113 terminates or abandons the writing of the in-flight operations to the memory device 140, while continuing to write the host data associated with the in-flight operations to the ultra-high endurance storage class memory device 140. Advantageously, the in-flight data written to and stored in the ultra-high endurance storage class memory device 140 may be used in a subsequent data recovery process, following the power loss event.

In an embodiment, the data management component 113 causes host data relating to one or more programming operations to be written to the memory device 130 during normal operation. In this embodiment, in response to the identification of a power loss event, the data management component 113 identifies one or more in-flight operations and switches the writing of the in-flight data from the memory device 130 to the ultra-high endurance storage class memory device 140. terminates or abandons the writing of the in-flight operations to the memory device 140, while continuing to write the host data associated with the in-flight operations to the ultra-high endurance storage class memory device 140. Advantageously, the storage capacitance required in the memory device 140 is reduced, as compared to a typical TLC or QLC memory device, since the in-flight data can be written to and stored in the ultra-high endurance storage class memory device 140 in response to a power loss event. Further details with regards to the operations of data management component 113 are described below.

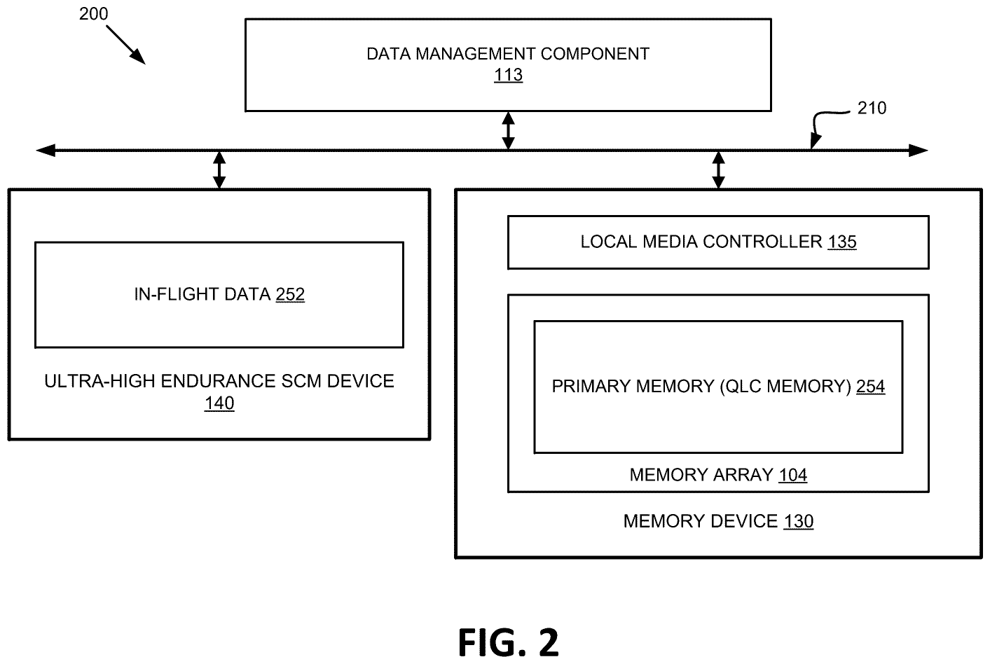

FIG. 2 is a block diagram 200 illustrating a memory sub-system configured for using ultra-high endurance storage class memory as a media management data buffer in accordance with some embodiments of the present disclosure. In one embodiment, data management component 113 is operatively coupled with memory device 130 and with ultra-high endurance storage class memory device 140. For example, the memory sub-system may include a shared communication bus 210 between data management component 113, memory device 130, and ultra-high endurance storage class memory device 140, as well as possibly other components (not shown). In one embodiment, the communication bus 210 utilizes an Open NAND Flash Interface (ONFI) bus architecture to enhance data transfer rates in the memory subsystem. The ONFI bus architecture enables advanced data parallelism, dynamically adaptable error correction capabilities, and intelligent command queuing.

In one embodiment, memory device 130 includes local media controller 135 and memory array 104. Memory array 104 can include an array of memory cells formed at the intersections of wordlines and bitlines. In one embodiment, the memory cells are grouped in to blocks, which can be further divided into sub-blocks, where a given wordline is shared across a number of sub-blocks, for example. In one embodiment, each sub-block corresponds to a separate plane in the memory array 104. The group of memory cells associated with a wordline within a sub-block is referred to as a physical page. In one embodiment, there can be at least a portion of the memory array 104 where the sub-blocks are configured as QLC memory and which can be used as primary memory 254. Depending on how they are configured, each physical page in one of the sub-blocks can include multiple page types. For example, a physical page formed from single level cells (SLCs) has a single page type referred to as a lower logical page (LP). Multi-level cell (MLC) physical page types can include LPs and upper logical pages (UPs), TLC physical page types are LPs, UPs, and extra logical pages (XPs), and QLC physical page types are LPs, UPs, XPs and top logical pages (TPs). For example, a physical page formed from memory cells of the QLC memory type can have a total of four logical pages, where each logical page can store data distinct from the data stored in the other logical pages associated with that physical page. Depending on the embodiment, the primary memory 254 can be configured as some other type of memory besides QLC memory, such as multi-level cell (MLC) memory, triple level cell (TLC) memory, penta-level cell (PLC) memory, or any combination of such.

Depending on the programming scheme used, each logical page of a memory cell can be programmed in a separate programming pass, or multiple logical pages can be programmed together. For example, in a QLC physical page, the LP and UP can be programmed on one pass, and the XP and TP can be programmed on a second pass. Other programming schemes are possible. In one embodiment, data management component 113 can receive, for example, four pages of host data to be programmed to primary memory 254. Accordingly, in order for one bit from each of the four pages to be programmed to each memory cell, local media controller 135 can cause each memory cell to be programmed to one of 16 possible programming levels (i.e., voltages representing the 16 different values of those four bits). Thus, the four pages of host data will be represented by 16 different programming distributions.

In one embodiment, data management component 113 detects a power loss event and causes host data relating to in-flight media access operations (in-flight data 252) to be stored in the ultra-high endurance storage class memory device 140. According to embodiments, the in-flight data 252 can be stored in one or more data structures (e.g., tables) stored in the ultra-high endurance storage class memory device 140, such that the data structures can be read from or written to by the data management component 113. In an embodiment, the data management component 113 determines if a condition is satisfied, and if so, causes termination of the writing of the in-flight data 252 from the ultra-high endurance storage class memory device 140 to a primary memory 254 of the memory device 130. In an embodiment, the data management component 113 determines the condition is satisfied if a programming time (tPROG) associated with the one or more in-flight operations is greater than a threshold programming time. Accordingly, in the event of a power loss, the in-flight data 252 does not need to be committed to the memory device 130 since it is stored in the ultra-high endurance storage class memory device 140. This results in a reduction of capacitors needed to provide additional hold-up energy, which frees up space on the circuit board of the memory device 130.

In one embodiment, the data management component 113 causes in-flight data 252 relating to the one or more in-flight operations to be concurrently written to the ultra-high endurance storage class memory device 140 and the primary memory 254 of the memory device 130. In this embodiment, in response to the detection of a power loss event by the data management component 113, the data management component 113 causes termination or abandonment of the writing of the in-flight data 252 to the memory device 130, while continuing to write the in-flight data 252 to the ultra-high endurance storage class memory device 140.

In one embodiment, the data management component 113 causes in-flight data 252 relating to the one or more in-flight operations to be written to the primary memory 254 of the memory device 130. In this embodiment, in response to the detection of a power loss event by the data management component 113, the data management component 113 switches the writing of the in-flight data 252 from the memory device 130 to the ultra-high endurance storage class memory device 140 (i.e., abandons writing the in-flight data 252 to the memory device 140 and causes writing of the in-flight data 252 to the ultra-high endurance storage class memory device 140).

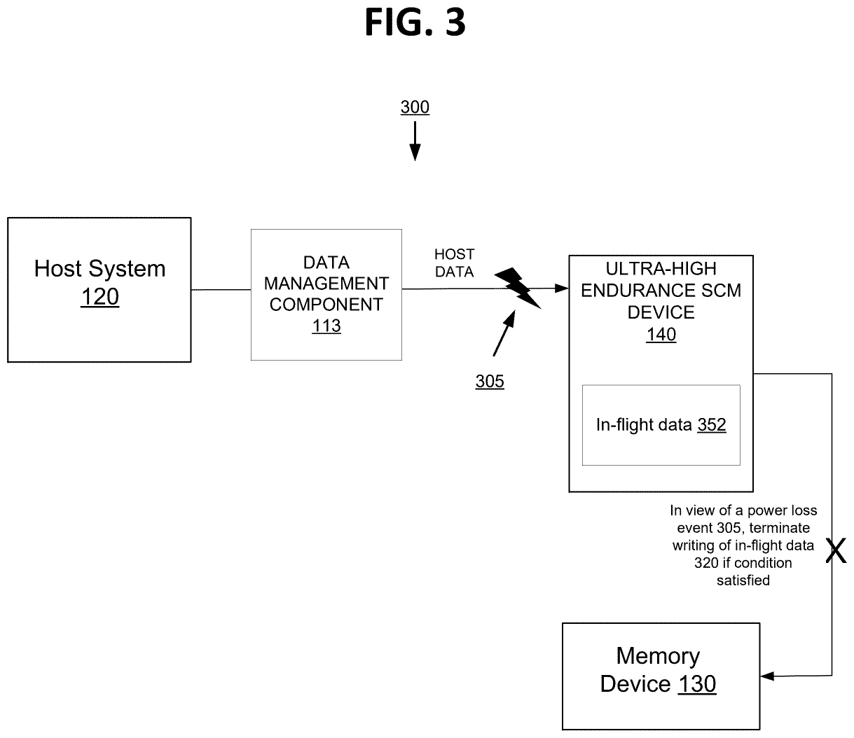

FIG. 3 is a block diagram 300 illustrating components of a memory sub-system configured for using an ultra-high endurance storage class memory device 140 to store host data associated with one or more in-flight operations (i.e., in-flight data) in view of a power loss event, in accordance with embodiments of the present disclosure. Advantageously, the ultra-high endurance SCM device 140 is a non-volatile and persistent memory location.

As illustrated in FIG. 3, in-flight data 352 associated with one or more in-flight operations 320 is caused to be stored in the ultra-high endurance SCM device 140 by the data management component 113 (e.g., the data management component 113 of the memory sub-system controller 115 of FIG. 1). In an embodiment, the ultra-high endurance storage class memory device 140 serves as a buffer for storing the in-flight data 320, such that the in-flight data 352 is first stored in the ultra-high endurance storage class memory device 140 and subsequently written to the memory device 130.

In this embodiment, in response to detection or identification of a power loss event 305, the data management component 113 causes termination of the writing of at least a portion of the in-flight data 352 from the ultra-high endurance storage class memory device 140 to the memory device 130 if a condition is satisfied. In an embodiment, the data management component 113 determines that the condition is satisfied if a programming time associated with the in-flight data 352 is greater than a threshold programming time. For example, in response to a power loss event, the data management component 113 sends a query to the memory device to determine a percentage of the programming that is completed or a number of programming pulses that have been completed.

In an embodiment, if the condition is not satisfied (i.e., the programming time associated with the one or more in-flight operations is less than the threshold programming time), the data management component 113 allows the writing of the in-flight data 352 from the ultra- high endurance storage class memory device 140 to the memory device 130 to complete.

According to embodiments, the in-flight data 352 stored in the ultra-high endurance storage class memory 140 can be used in a subsequent data recovery operation following the power loss event. Advantageously, by storing in-flight data 352 in the ultra-high endurance SCM device 140 and, in response to a power loss event, terminating the writing of the in-flight data 352 if the above-described condition is satisfied, the storage capacitance of the memory device 130 and associated energy cost are reduced, while maintaining data reliability.

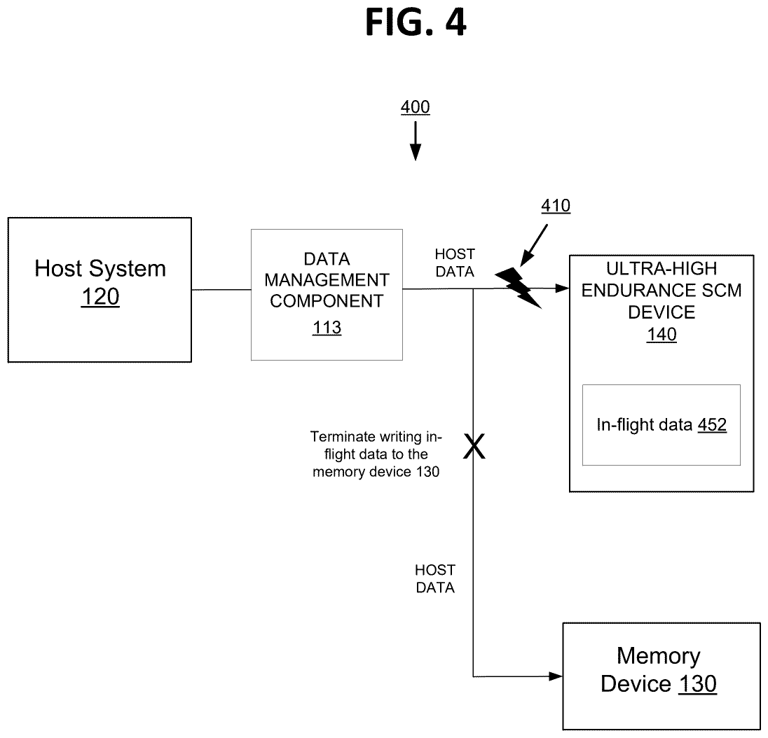

FIG. 4 is a block diagram 400 illustrating a data management component 113 of a memory sub-system configured to cause host data associated with one or more media access operations to be written to an ultra-high endurance storage class memory 140 and a memory device 130. In an embodiment, the data management component 113 detects an occurrence of a power loss event. In response to detection of the power loss event, the data management component 113 terminates or abandons the writing of the host data associated with the one or more in-flight operations (i.e., the in-flight data 452) to the memory device 130 while continuing to write the in-flight data 452 to the ultra-high endurance storage class memory device 140 to proceed. for using an ultra-high endurance storage class memory device 140 to store host data associated with one or more in-flight operations (i.e., in-flight data) in view of a power loss event, in accordance with embodiments of the present disclosure.

In an embodiment, the data management component 113 identifies information associated with the one or more in-flight operations that are abandoned with respect to the memory device 130 (also referred to as “abandoned in-flight data”). In an embodiment, the data management component 113 stores the abandoned in-flight data as metadata stored in the ultra-high endurance storage class memory device 140 (i.e., the non-volatile and persistent memory location). In an embodiment, the data management component 113 uses the metadata associated with the abandoned in-flight data to execute a data recovery process, following the power loss event.

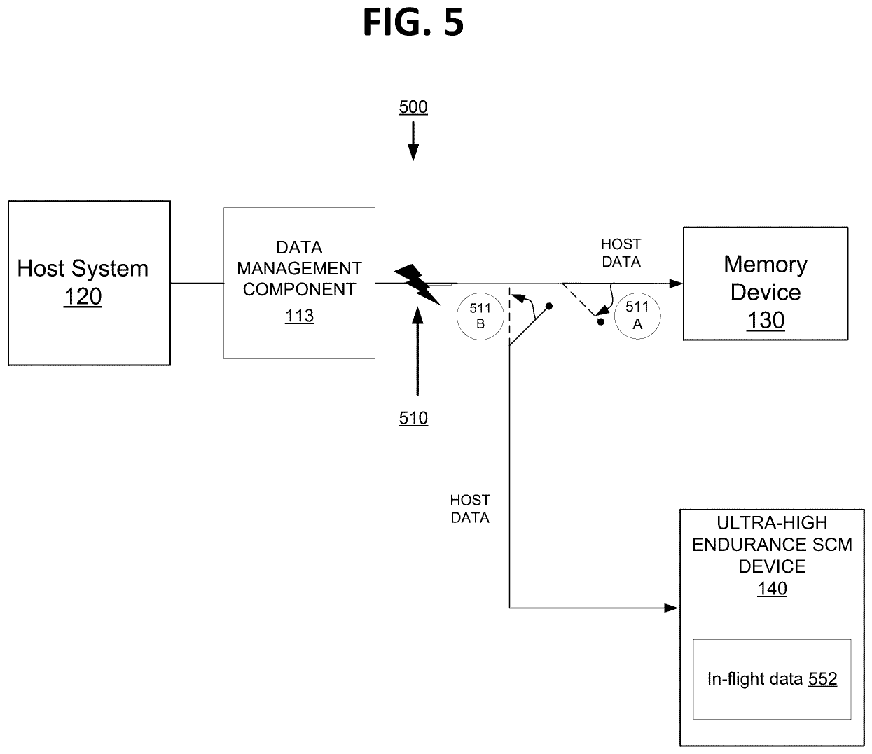

FIG. 5 is a block diagram 500 illustrating a data management component 113 of a memory sub-system configured to cause host data associated with one or more media access operations to be written to a memory device 130 during normal operation, and, in response to a power loss event 510, cause the writing of the in-flight data 552 to be “switched” from the memory device 130 to the ultra-high endurance storage class memory device 140. In an embodiment, upon detection of the power loss event 510, the data management component 113 causes the switch by executing action 511A to abandon writing the host data to the memory device 130 and executing action 511B to enable writing of the host data associated with the one or more in-flight operations (i.e., the in-flight data 552) to the ultra-high endurance storage class memory 140. In an embodiment, in response to detection of the power loss event 510, the switching actions 511A, 511B may be performed logically (i.e., without a physical switch) by the data management component 113 by abandoning the writing of the in-flight data to the memory device 130 and enabling the writing of the in-flight data to the ultra-high endurance storage class memory device 140

In this embodiment, the data management component 113 identifies information associated with the one or more in-flight operations that are switched from the memory device 130 to the ultra-high endurance storage class memory device 140 and stores the information as metadata in the ultra-high endurance storage class memory device 140. In an embodiment, following the power loss event and return to normal operation, the data management component 113 uses the metadata associated with the abandoned in-flight data to execute a data recovery operation or process.

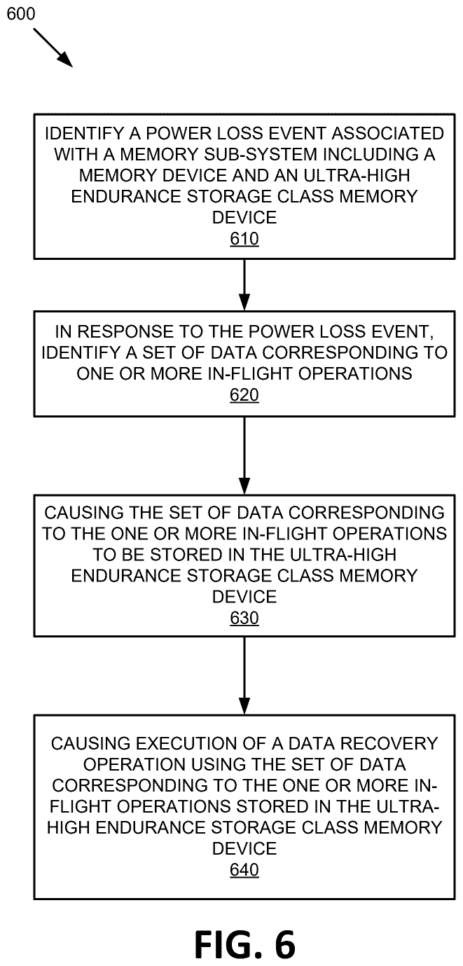

FIG. 6 is a flow diagram of an example method of using ultra-high endurance storage class memory to store host data associated with one or more in-flight operations in view of a power loss event associated with a memory sub-system including a memory device and an ultra-high endurance storage class memory device, in accordance with one or more embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by data management component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In an embodiment, during normal operation, the set of data corresponding to the one or more in-flight operations is stored in the ultra-high endurance storage class memory device only, and later written from the ultra-high endurance storage class memory device to the memory device, as described in detail above with reference to FIG. 3.

In another embodiment, during normal operation (i.e., in the absence of a power loss event), a set of data corresponding to one or more in-flight operations (e.g., one or more media access operations initiated by a host system that are in-progress) is stored concurrently in both the ultra-high endurance storage class memory device and the memory device, as described in detail above with reference to FIG. 4.

In another embodiment, during normal operation, the set of data corresponding to the one or more in-flight operations is stored in the memory device, as described in detail above with reference to FIG. 5.

At operation 610, the processing logic (e.g., data management component 113) identifies a power loss event associated with a memory sub-system including a memory device (e.g., memory device 130 of FIGS. 1-5) and an ultra-high endurance storage class memory device (e.g., ultra-high endurance storage class memory device 140 of FIGS. 1-5). The power loss event can include any interruption or loss of power, including an asynchronous power loss event.

At operation 620, in response to the power loss event, the processing logic identifies a set of data (e.g., in-flight data 252, 352, 452, and 552 of FIGS. 2-5, respectively) corresponding to one or more in-flight operations (e.g., one or more media access operations that are in-progress at a time of the power loss event).

At operation 630, the processing logic causes the set of data corresponding to the one or more in-flight operations to be stored in the ultra-high endurance storage class memory device. In an embodiment, following the power loss event, the processing logic causes the termination of the writing of one or more portions of the in-flight data from the ultra-high endurance storage class memory device to the memory device if a condition is satisfied. In an embodiment, the processing logic determines the condition is satisfied if a programming time (tPROG) associated with the one or more portions of in-flight operations is greater than a threshold programming time.

In an embodiment, in response to the power loss event identified in operation 610, the processing logic terminates the writing of the in-flight data to the memory device, while writing the in-flight data to the ultra-high endurance storage class memory device. In another embodiment, in response to the power loss event, the processing logic switches from writing the in-flight data to the memory device to writing the in-flight data to the ultra-high endurance storage class memory.

In an embodiment, during normal operation, the processing logic causes the set of data corresponding to the one or more in-flight operations to be stored in the memory device. In this embodiment, in response to the power loss event, the process logic terminates the writing of the in-flight data to the memory device and initiates the writing of the in-flight data to the ultra-high endurance storage class memory device.

At operation 640, the processing logic causes execution of a data recovery operation using the set of data corresponding to the one or more in-flight operations stored in the ultra-high endurance storage class memory device.

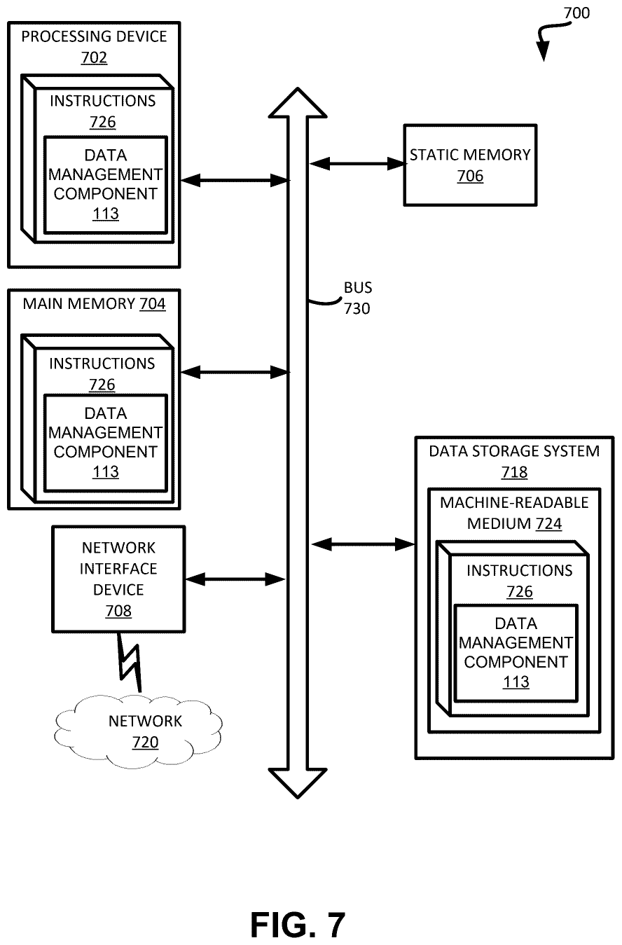

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or Rambus DRAM (RDRAM), etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to the data management component 113 of FIG. 1). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device;
an ultra-high endurance storage class memory device; and
a processing device, operatively coupled with the memory device and the ultra-high endurance storage class memory device, to perform operations comprising:
identifying a power loss event associated with the memory sub-system;
in response to the power loss event, identifying a set of data corresponding to one or more in-flight operations associated with the memory device;
causing the set of data corresponding to the one or more in-flight operations to be stored in the ultra-high endurance storage class memory device; and
causing execution of a data recovery operation using the set of data corresponding to the one or more in-flight operations to be stored in the ultra-high endurance storage class memory device.

2. The memory sub-system of claim 1, the operations further comprising:
following the power loss event, determining that a condition is satisfied; and
in response to determining that the condition is satisfied, terminating a writing of at least a portion of the set of data from the ultra-high endurance storage class memory device to the memory device.

3. The memory sub-system of claim 2, wherein the condition is satisfied if a programming time associated with programming the at least the portion of the set of data is greater than a threshold programming time.

4. The memory sub-system of claim 1, wherein prior to the power loss event, the set of data corresponding to the one or more in-flight operations is written to the ultra-high endurance storage class memory device and the memory device concurrently.

5. The memory sub-system of claim 4, the operations further comprising, in response to the power loss event, terminating a writing of at least a portion of the set of data corresponding to the one or more in-flight operations to the memory device.

6. The memory sub-system of claim 1, wherein prior to the power loss event, the set of data corresponding to the one or more in-flight operations is written to the memory device.

7. The memory sub-system of claim 6, the operations further comprising, in response to the power loss event:
terminating a first writing of at least a portion of the set of data corresponding to the one or more in-flight operations to the memory device; and
initiating a second writing of the at least the portion of the set of data corresponding to the one or more in-flight operations to the ultra-high endurance storage class memory device.

8. A method comprising:
identifying a power loss event associated with a memory sub-system comprising a memory device and an ultra-high endurance storage class memory device;
in response to the power loss event, identifying a set of data corresponding to one or more in-flight operations associated with the memory device;
causing the set of data corresponding to the one or more in-flight operations to be stored in the ultra-high endurance storage class memory device; and
causing execution of a data recovery operation using the set of data corresponding to the one or more in-flight operations to be stored in the ultra-high endurance storage class memory device.

9. The method of claim 8, further comprising:
following the power loss event, determining that a condition is satisfied; and
in response to determining that the condition is satisfied, terminating a writing of at least a portion of the set of data from the ultra-high endurance storage class memory device to the memory device.

10. The method of claim 9, wherein the condition is satisfied if a programming time associated with programming the at least the portion of the set of data is greater than a threshold programming time.

11. The method of claim 8, wherein prior to the power loss event, the set of data corresponding to the one or more in-flight operations is written to the ultra-high endurance storage class memory device and the memory device concurrently.

12. The method of claim 11, further comprising, in response to the power loss event, terminating a writing of at least a portion of the set of data corresponding to the one or more in-flight operations to the memory device.

13. The method of claim 8, wherein prior to the power loss event, the set of data corresponding to the one or more in-flight operations is written to the memory device.

14. The method of claim 13, further comprising, in response to the power loss event:
terminating a first writing of at least a portion of the set of data corresponding to the one or more in-flight operations to the memory device; and
initiating a second writing of the at least the portion of the set of data corresponding to the one or more in-flight operations to the ultra-high endurance storage class memory device.

15. A non-transitory computer-readable storage medium comprising instructions that, when executed by a processing device, cause the processing device to perform operations comprising:
identifying a power loss event associated with a memory sub-system comprising a memory device and an ultra-high endurance storage class memory device;
in response to the power loss event, identifying a set of data corresponding to one or more in-flight operations;
causing the set of data corresponding to the one or more in-flight operations to be stored in the ultra-high endurance storage class memory device; and
causing execution of a data recovery operation using the set of data corresponding to the one or more in-flight operations to be stored in the ultra-high endurance storage class memory device.

16. The non-transitory computer-readable storage medium of claim 15, the operations further comprising:
following the power loss event, determining that a condition is satisfied; and
in response to determining that the condition is satisfied, terminating a writing of at least a portion of the set of data from the ultra-high endurance storage class memory device to the memory device.

17. The non-transitory computer-readable storage medium of claim 16, wherein the condition is satisfied if a programming time associated with programming the at least the portion of the set of data is greater than a threshold programming time.

18. The non-transitory computer-readable storage medium of claim 15, wherein prior to the power loss event, the set of data corresponding to the one or more in-flight operations is written to the ultra-high endurance storage class memory device and the memory device concurrently.

19. The non-transitory computer-readable storage medium of claim 18, further comprising, in response to the power loss event, terminating a writing of at least a portion of the set of data corresponding to the one or more in-flight operations to the memory device.

20. The non-transitory computer-readable storage medium of claim 15, wherein prior to the power loss event, the set of data corresponding to the one or more in-flight operations is written to the memory device; the operations further comprising:
terminating a first writing of at least a portion of the set of data corresponding to the one or more in-flight operations to the memory device; and
initiating a second writing of the at least the portion of the set of data corresponding to the one or more in-flight operations to the ultra-high endurance storage class memory device.
